(19) United States
(12) Patent Application Publication
(10) Pub. No.: US 2011/0183305 A1
(43) Pub. Date: Jul. 28, 2011

(54) Behaviour Modification

(75) Inventor: Tuvi Orbach, London (GB)

(73) Assignee: HEALTH-SMART LIMITED, London, UK (GB)

(21) Appl. No.: 12/994,853

(22) PCT Filed: May 28, 2009
(86) PCT No.: PCT/GB09/50584

§ 371 Date: Feb. 17, 2011

(30) Foreign Application Priority Data
May 28, 2008 (GB) GB0809563

(51) Int. Cl. G09B 19/00

(52) U.S. Cl. 434/236

(57) ABSTRACT

A behavioural modification system and method facilitates the achieving by a user (Q) of one or more objectives. The system includes sensors (12) to measure at least one physiological or psychological parameter of the user; a memory to store data concerning the physiological or psychological parameter or a range of physiological or psychological parameters for the user, based on information from the sensors at at least one point in time; and a comparator to compare the at least one measured parameter at subsequent points in time with stored data for the user. It also includes an indicator (16) to provide information to the user (Q) about one or more objectives; a monitor (20) that, based on comparisons made by the comparator, monitors the state of the user when working towards the at least one objective; and a moderator that, in response to the state of the user as monitored by the monitor, enables the at least one objective to be changed so that the user is able to maintain a desired state when attempting the at least one objective thereby maintaining engagement of the user to continue working towards the at least one objective.

### FIELD OF THE INVENTION

The present invention relates to a behaviour modification system and method for facilitating at least one objective of changing an unhealthy habit or adopting a desired habit for an individual. In particular, but not exclusively, the system may be used to motivate and coach an individual and empower him to create a sustainable positive change in his physiological, emotional, mental or behavioural processes, so that the objectives are achievable by a person within their own personal capacity. It is further envisaged that the system will provide the motivation, habit, tools and skills for an individual to continue with the implementation and improvement of the skills and habits acquired with the system in his daily life and over a period of time.

### BACKGROUND OF THE INVENTION

In modern life, individuals are placed under increasing stress, which can affect not only the physical health of the individual but also the mental health. This in turn has effects on a person's performance of daily tasks, and ability and motivation to learn new skills or break old habits. We can define a “habit” as an internal routine that has been encoded within the person consciously or subconsciously, and causes his internal or external behaviour to perform in a specific way depending on various internal or external parameters. For example: an external habit that was acquired by conscious training is brushing of your teeth; while an internal habit that was acquired subconsciously is to feel angry or sad when another person tells you that you are wrong or ugly. This can lead to external behaviour of shouting or crying, and to internal changes in your physiology and hormones. Such an internal habit can also increase heart rate and blood pressure. Some of the habits, such as what we eat, have been created and encoded deep in ourselves by combination of many years of repeated behaviour (e.g. adding sugar to our coffee or salt to a salad, or drinking coffee every morning which gradually changes our taste, and may even create addiction or craving), unconscious psychological influence (media advertisement, peer group pressure, parents), and conscious decisions (to eat healthier). It is not easy to change such habits, to reprogram these internal routines which may be encoded deep in our brain and body.

A number of devices and methods have been used to help people achieve their goals in life and to change habits. Such goals may be to deal with mental or emotional issues, such as the treatment of phobias or anxiety or to deal with psychological conditions such as post traumatic stress conditions or addictions, such as cravings for alcohol, food or nicotine. One such example involves hypnosis where one person, the hypnotherapist interacts with another person, the subject. Another technique to train users to change behaviour is biofeedback. A biofeedback therapist attaches one or more sensors to the client and instructs him how to change specific aspect of his physiology. However, neither of these methods is widely applicable, or convenient, and they need an expert to train the users to change their behaviour. Another method is group therapy, but group therapy sessions require an expert if they are to be effective.

The present invention aims to overcome the disadvantages of the prior art by providing a system and a method that not only avoids the need for an expert, but is more effective at empowering people to change their habits.

### STATEMENTS OF INVENTION

According to a first aspect of the invention, there is provided a behaviour modification system to facilitate the achieving by a user of one or more objectives to acquire habits or skills or to change undesirable habits, said system including

(a) one or more sensors to measure at least one physiological or psychological or behavioural parameter of the user, or user responses;
(b) a memory to store data concerning the measured parameter or a range of measured parameters for the user, or user responses, based on information from the sensors at at least one point in time;
(c) a comparator to compare the at least one measured parameter at subsequent points in time with stored data for the user;
(d) an indicator to provide information to the user about one or more objectives that the user wishes to achieve;
(e) a monitor that, based on comparisons made by the comparator, monitors the state of the user when working towards the at least one objective; and
(f) a moderator that, in response to the state of the user as monitored by the monitor, enables the at least one objective to be changed so that the user is able to maintain a desired state when attempting the at least one objective thereby maintaining engagement of the user to continue working towards the at least one objective.

In a second aspect the invention provides a behaviour modification system comprising one or more sensors to measure at least one physiological or psychological or behavioural parameter of the user; and an electronic device provided with a multimedia display and responsive to the measured parameter, the electronic device being arranged to train the user, using the multimedia display, to achieve a state of mind in which the user is engaged and his attention is focused on learning and practising an achievable task or behaviour; and then, when the user has this state of mind, to train the user to achieve a desired objective. The desired objective might be to improve a specific habit or behaviour, or an attitude or a physiological or emotional or mental process, or a subconscious schema or to learn a new skill.

The system and method of the invention can help the user to reprogram deeply ingrained routines, and to change his unhealthy habits and acquire desirable habits. It includes several stages: 1) the system monitors the user, interviews him and creates a comprehensive assessment of the user's personality, needs, health risks and preferences; 2) the system coaches the user to achieve an optimum state of mind and body in which the user is able and willing to change his internal processes; 3) when the user reaches such state of mind, the system coaches him how to improve his habit or acquire the desired skills. This stage is done by interactive training with the system. If the habit or skill can be performed within a session (e.g. to improve a breathing pattern) this third stage calls for practice and repetition with the system. If the habit can only be implemented in daily life (e.g. eating more fruit every day), then in the third stage the system coaches the user, and motivates him using engaging multimedia and visualisation techniques to implement the changes in his daily life. The system can provide him with a personalised plan how to implement the new skills or habits in his daily life, via mobile phone, a mobile audio player or printout instructions. As a final stage, 4) the user is implementing the new acquired skill or habit (or has stopped the unhealthy habit) in his daily life according to the personalised plan and what he learned in the previous stages. If the system is implemented in a mobile device (e.g. a mobile phone), the device can remind him and help him to practice the new habit/skill in his daily life.

The system contains tools, processes and protocols which enable it to increase the user's motivation, confidence, and enjoyment of learning and practising the new behavioural changes and implementing them in his life. Furthermore the system contains tools, processes and protocols which train and motivate the user to practise and repeat each new habit or task many times during interactive sessions and in his daily life; and the level of the tasks can increase: starting with an easy-to-achieve task, and gradually during the practice and repetition of the task or habit, increasing the difficulty according to the ability of the user to achieve and implement the task.

Thus the invention coaches a user to achieve a state of mind and body which is open to learning new techniques, and monitors when he is in such a state; it motivates the user, increases his confidence, interacts with the person to learn his conscious and unconscious reactions and preferences, customises the instructions to the person's responses, to his psychological and physiological profile, to his specific habits, needs and goals, and coaches the person to actively take part in the processes in order to change behaviour patterns or to learn new skills and implement them in his daily life. The invention has the advantage that a person can actively participate in the change process and is also motivated to maintain the change process and implement it in his life. It has the further advantage that the motivation and confidence can be maintained and increased by real time interaction with the user, monitoring his conscious and unconscious reactions using an expert knowledge base customised to the person's needs and his proactive involvement and participation in the process.

The system may therefore comprise an electronic device including processor and memory, which can store, process and update protocols to coach users to improve their behaviour according to at least one of the following elements: present state of the user, past states of the user, user medical status and medical history, user psychological history, user symptoms, user constitution, user preferences, user nutrition and eating habits, other user habits including addictions, any modifiable and non-modifiable risks, medical knowledge, psychological knowledge, sport expertise, music expertise, short term objective, long term objective, or any combination of the previous elements.

The objective can be a short term objective during the session, such as increasing the length of exhalation, or a long term objective such as reducing blood pressure or weight or increasing confidence and happiness. Some objectives are linked directly to changing the values of measured parameters; whereas other objectives are not so connected, and are typically longer term objectives. Progress towards some of these objectives may require direct input by the user, in order for the system to monitor the user's state. For example the user's emotional state may be monitored by having the user complete a questionnaire, or asking the user to report their own emotional state (for example, anxiety on a scale 0 to 10).

Preferably the measurements are non-invasive measurements of physiological parameters, or involve analysing the user's voice, or breathing, or facial expression or deportment. Such measurements enable the mental state or emotional state of the user to be monitored. The sensor or sensors may monitor physiological changes in his body such as blood flow or heart rate, or behaviour such as breathing patterns or deportment, or using a microphone to analyse his voice.

For example the sensor may be a blood flow monitor or heart rate monitor. The sensor may be in the form of a clip that is attached to the finger, the toe or the ear-lobe of the user or his wrist, and blood flow is monitored over a period of time. Parameters measured may include pulse and/or heart rate; or the sensor can be a microphone with a processor that can analyse the voice of the user, or the sensor can be an ECG, or respiration sensors or thermometer, EEG, GSR, accelerometer, video camera with software that can analyse facial expressions, or any combinations of these sensors. The system can also be linked to the user's medical record to receive information about the user and/or to update the medical record.

It is preferred that the physiological parameter is selected from one or more of the heart rate, blood pressure, respiration rate and pattern, galvanic skin resistance, temperature, brainwave activity of the user, or voice analysis. The sensors used are specific for the parameter to be measured, for example a heart rate monitor will be used to measure heart rate, or a respiration monitor will be used to measure respiration patterns and or rate of breathing. In a relaxed state, breathing tends to be deeper and slower and with longer exhalations.

It is envisaged that the sensor may be a disposable one-use sensor, which is attached to other components of the motivational system. The sensors may be portable sensors which are attachable to the device by way of ports or attachment members or by wireless connection such as Bluetooth (trade mark), and this allows for the interchange of disposable or reusable sensors. It is envisaged that an individual sensor may be allocated to a particular individual, and the sensor may be calibrated and stored for use by that user and updated by the particular user when required.

Alternatively, the sensors may be integral with the motivational system, and, if required, can be cleaned between being used by different users.

It is a possibility that the system includes a plurality of sensors for measuring one physiological parameter substantially simultaneously, to obtain an average value for the physiological parameter, or to detect differences in its value between specific places in the body. In such an arrangement, sensors can be placed on different parts of the body, the readings taken, and an average value (or difference values) calculated to give a value for the physiological parameter. This reduces the risk of false readings which may result from variabilities in the body, for example poor circulation in the extremities, or artefacts arising from movements.

It is further envisaged that the system may include a plurality of different sensors measuring a plurality of different parameters. If a number of different parameters are measured, these can be compared with data for the user showing when he or she is in a relaxed state, and because different parameters are measured, the values obtained can be cross checked to establish the mental state/neurological state of the user. This reduces the risk of a false representation of the mental, emotional and physiological state of the user. By using several parameters the system can monitor more than one dimension and coach the person to achieve better state of mind. For example the system can monitor the user heart rate and train him to increase and stabilise his heart rate variability and at the same time to increase his exhalation length and skin resistance.

It is preferred that the memory is integral with a computer or processor. Preferably the computer is a portable device such as a mobile phone that can be moved between locations. However, the memory or part of it may be in the form of a stand-alone portable memory device, such as a memory stick, which can be used with a computer at a fixed location.

In a particularly preferred arrangement, the memory is included in a mobile communications device such as a mobile phone. The display of the mobile phone can then be used to give a visual representation of the data collected from the individual whose physiological parameters are measured and the audio output with or without headphone can be use for audio feedback and coaching, while the microphone can be used as an input sensor. Preferably the display is in real-time. This has the advantage that the user can see how his body is performing in real life and learn to improve his state of body and mind accordingly.

It is envisaged that the memory may alternatively be a memory connected to an interactive television. The interactive television may be a stand-alone device or it can be included in a games console. The system can be incorporated also in a games console, either a portable hand-held games console or one that can be connected to external TV or display.

In a preferred arrangement, the sensor is in wireless communication with the memory and this allows for the whole arrangement to be portable. The sensor may be separate from the device including the memory or it may be incorporated in the memory-containing device. For example, the sensor may be incorporated in a mobile phone or communicate with it with Bluetooth or another protocol.

It is envisaged that in order for the individual to become engaged with their personal development, and become aware of their state of mind and body, information relating to the one or more physiological parameters that is transmitted to the memory is displayed in real time on a screen, and/or converted to relevant audio feedback.

In one arrangement, the screen is integral with the device that includes the memory. However, the memory may be within one device, for example a hand held console, and the console can be connected to a screen that is separate from the device including the memory. Such an arrangement allows the device to be used with a television screen that can be viewed by the user or an audience, so there is increased user involvement because of the magnification of the display.

It is often very beneficial for a user if they can see the results of their actions and compare them with optimum values. The parameters measured for the user are shown as a first image and a second image is provided showing a range of values that indicate a desired state. For example if the goal is to train the user to a correct breathing pattern, the system will monitor the existing user's rate and breathing pattern and may display it to the user in a form of animated graph in one colour, displaying the next improved breathing pattern in a second colour and the optimised goal breathing pattern in a third colour. At the same time the system may coach the user with audio instructions based on real-time monitoring of the user's respiration pattern. The user will try to improve his breathing pattern, for example to breathe deeply, slowly, with longer exhalation and to match his breathing graph with the next desired one. The system may continue to change the next desired pattern and lead the user to an optimised pattern in stages. In this way the system implements a pace and lead method, first monitoring the existing user's pace and patterns, displaying them to the user and asking the user to follow these patterns. Because the user has to follow his existing natural pattern it is very easy. The system can give him positive feedback, and this will increase his motivation, confidence and enjoyment of the experience. Then the system will lead the user gently to a better pattern but close to the user's existing pattern. When the user gets used to the improved pattern the system will continue to lead him to a better pattern until the user will be trained to behave in the optimum pattern—breathing deeply, slowly with longer exhalation for example.

The system may use any combination of visual and audio feedback and instructions, including music, words, graphs, animation, video etc. It can also provide feedback and instruction according to the user's preference and personality, e.g. only audio feedback for a visually impaired person or only visual feedback for a deaf person. The system can also learn the best methods to communicate with the user and uses words, pictures, animations, colours, music and audio that the user prefers or that will be more effective to motivate and influence the specific user according to his culture, personality and constitution. Preferably the communication is multimedia, using pictures, animation, and video as well as words, and possibly also music, as the user is more effectively engaged if a rational presentation is combined with an appeal to the user's emotions.

The behaviour modification system may have the capability to coach the user using at least one of the following media: audio, visual, multimedia, video, tactile and vibration, or any combinations of these media.

The behaviour modification system trains the user to improve his state of mind and body to be more open to learning and change. It may implement at least one of the following methods: create and enhance the user's motivation, both intrinsic (concerned with emotion) and extrinsic (based on logic); increase the user's confidence, by providing tasks at which the user can be successful, and by providing positive feedback; add specific elements during the coaching session so that the user will enjoy the coaching process; and coach the user to repeat new methods that he is learning several times during the sessions. The system may coach the user to practice new methods that he is learning many times in his daily life, interview the user to discover his objections to specific changes and his readiness to specific changes and coach him accordingly, give the user a personal progress plan to implement in his daily life according to his needs, coach the user how he can enjoy his life more when he implements the desired changes in his life, review how the user has implemented his personal plan, coach the user using any psychological or behavioural technique or therapy such as cognitive behavioural therapy, positive psychology methods, emotional intelligence methods, motivational interview, mindfulness, NLP (neurolinguistic programming), coach the user according to his belief, or any combination of these.

The preferred behaviour modification system will implement all of the following: increase user's motivation, during the session and after the session, increase intrinsic and extrinsic motivation, increase the user's confidence, train the user to improve his state of mind and body, coach the user to repeat new methods that he is learning several times during the sessions and in his daily life, and in such a way that the user experiences enjoyment. It will use the information about the present state of the user and his responses together with information from the past, and customise the instructions according to the specific needs of this specific user at the present to assist him to achieve the desirable changes, and implement these changes in his daily life.

The behaviour modification system may monitor at least one of the following: heart rate, ECG, blood flow, galvanic skin resistance, brainwave activity, respiration, user's voice, temperature, movements, blood pressure, user's answers to questions, or any derivation, calculation and combination of these parameters.

The behaviour modification system may use a plurality of different sensors measuring a plurality of different physiological parameters. For example the system can use an ECG attached to the user's chest or wrists and a photo-plethysmograph, to calculate heart rate variability and pulse transit time (i.e. the time interval between the electrical pulse at the heart, and the pressure pulse reaching a specified point in the body such as a fingertip), and use these parameters to create scores which may be used to instruct and train the user to achieve a short term or long term objective related to these parameters.

Further, the user can be taught an affirmation which is a positive statement, such as “I will relax”, which may further contribute to the relaxation process.

Further, the user can be taught to breathe with a specific pace and pattern by following particular music. He can learn this music during the session or listen to it on a mobile device or at home while practicing breathing exercise accordingly.

To increase the enjoyment of taking part in the motivational process, the visual reward may take the form of an animation or an avatar shown on a screen that is visible to the user. The avatar may show the individual achieving their goal. An example would be if the individual was trying to lose weight, the avatar could show him as he would look like if he lost a number of pounds or kilos. The perceived improvement in visual appearance could then be used as a motivational tool. To avoid too much loss of weight, the avatar could also warn the individual if the individual should reach a dangerous weight level. This visual incentive could be used to ensure that the individual keeps to an ideal weight control plan, neither gaining nor losing too much weight.

It is preferred that the motivational system further comprises an application for downloading content or an application for configuring the device from a remote source via the Internet or a mobile network. It is envisaged that not only the individual will have access to the information measured, but this information could also be sent to a remote location, for example, information could be sent to a hospital or to a clinic or advisor that is assisting the individual in achieving their goal. In addition, it is possible for content to be uploaded onto the system, for example a new goal or motivational plan or tool so that there is continual exchange of information between the user and a remote source.

The information from a remote source can be sent via the phone, the Internet, by wireless communication or even by way of a data carrier, such as a CD ROM or a memory stick for carrying a program which can be used to configure a computer to operate as motivational device as described above.

Thus the system can be implemented on a mobile phone combined with small wearable wireless sensors, with the option to update the system (add new applications or new version) remotely, and also with an option to have an interface with other systems such as the electronic health record of the user (e.g. at the doctor's office).

According to another aspect of the invention, there is provided a method of facilitating the achieving by a user of one or more desirable behaviour modification changes, said method including the steps of:

a) measuring at least one physiological, psychological or behavioural parameter of the user;
b) storing the data concerning the measured parameter or a range of measured parameters for the user, based on information from the sensors at at least one point in time;
c) comparing the at least one measured parameter at subsequent points in time with stored data for the user;
d) providing information to the user about one or more objectives that the user wishes to achieve;
e) monitoring, on the basis of the said comparisons, the state of the user when working towards the at least one objective; and
f) moderating, in response to the monitored state of the user, the at least one objective by amending the objective so that the user is able to maintain a desired state when attempting the at least one objective thereby maintaining engagement of the user to continue working towards the at least one objective.

According to yet another aspect of the invention, there is provided a method of facilitating the achieving by a user of one or more desirable behaviour modification changes, said method including the steps of: measuring at least one physiological, psychological or behavioural parameter of the user; and by means of an electronic device provided with a multimedia display and responsive to the measured parameter, training the user, using the multimedia display, to achieve a state of mind in which the user is engaged and focused on an achievable task; and then, when the user has this state of mind, training the user to achieve a desired objective.

The system can store many protocols that can be updated and customised to many needs, medical conditions, cultures and people's preferences and personalities.

Thus the system coaches the users according to a protocol to improve their behaviour according to at least one of the following elements: present state of the user, past states of the user, user medical history, user psychological history, user symptoms, user constitution, user preferences, user nutrition and eating habits, other user habits including addictions, medical knowledge, psychological knowledge, sport expertise, music expertise, short term objective, long term objective, or any combination of the previous elements.

Preferably the parameter or parameters are measured and recorded at many successive times, so that the variation of a measured parameter can be monitored over a period of time. This time period may be the time during which a user is using the system; or may be a period of hours, days or months, so that a user's improvement as a result of the coaching can be monitored.

As can be seen, the invention has particular advantages in that it provides for a system and method that provide a process that is very engaging, attractive and interesting both from an emotional and a cognitive/rational point of view of the user. This is because the system engages the user and so it is not seen as onerous. The use of interactive processes to control an action such as breathing trains the user to relax, to breathe slowly and deeply with longer exhalation. Also, as a person is relaxed, there is increased muscular relaxation.

Achieving relaxation by using a synchrony between heart-rate variability and breathing patterns teaches the individual to focus on the breathing, which further relaxes the user who can then be engaged using feedback through visualisation of a desired state. As the individual is working with his body, within its own limits, this enables an increase in the individual's belief that he can achieve what he wants (confidence), and it creates positive mental feedback, where the individual is absorbed in what he is doing, so creating high motivation and engagement in the process, with enjoyment but without undue stress. Where the individual is absorbed in such a way, this may be referred to as being “in the flow”—this implies that the individual is fully engaged in what he is doing, and that it involves some challenge, and that it is enjoyable while not putting the user under pressure. Being in the flow is highly effective in enabling an individual to focus his attention and will enable him to learn new habits and skills faster and more deeply. An effect of the present invention is to enable the user to learn how to be in the flow. In other words, the invention enables the user to learn to be in a smart mindset, in which learning new habits and skills is more effective.

The desired state (being in the flow) may be one referred to as “engaged relaxed awareness”, but the desired degree of relaxation will depend upon the nature of the objective. As a general rule, however, a reduction in stress is desirable when attempting to achieve an objective; so the desired state may be described as involving an acceptable level of pressure or of stress. Initially the user learns how to achieve the desired state of stress or relaxation, with the associated psychological and physiological characteristics; subsequently the user can learn how to achieve another objective, while being in the appropriate state of relaxation or stress at which he is at his most receptive to learning new skills and habits. Not only is this subsequent learning carried out while the user is at his most receptive, but the user will enjoy the learning process, and is already aware that he has been able to achieve the initial goals, providing confidence that he can achieve the next goals that are set.

Thus the system of the invention enhances or achieves at least one of: an optimal state of mind and body such that the user will be more calm and receptive to behavioural change; intrinsic and extrinsic motivation; user confidence that the system can be effective for him and that he can be successful in achieving a goal; repetition of a desired habit; and an element to enhance the user's enjoyment during training sessions and subsequent implementation in daily life. Preferably these are all achieved.

### BRIEF DESCRIPTION OF THE FIGURES

FIG. 1: shows a graph where the correlation between stress and the ability to learn new skills is shown;

FIG. 2: shows how stress levels can vary according to different types of activities carried out;

FIG. 3: shows a patient's heart rate and blood pressure, before and after training using the techniques of the present invention;

FIG. 4: shows a schematic diagram of a motivational system according to an embodiment of the invention;

FIG. 5: shows a screen that can be seen by a user.

### DETAILED DESCRIPTION OF THE INVENTION

Many people would like to make positive change in their lives (e.g. reduce weight, quit smoking, be happier, learn new skills etc), and the wellness industry is growing at high speed with advice on diet, lifestyle, personal habits, happiness, etc.

In order achieve change a person must reach a state of mind in which they are open and receptive to deep transformation. The invention includes a system and a process to coach the user to be in this optimal “smart mindset”. This has three characteristics. Firstly, it needs an optimal level of stress/arousal. When a person is too stressed, their mind and brain are not open to receive deep information, i.e. they have difficulty encoding information on a deep level, and so it is difficult for change to occur, because shallow encoding means that the information is unlikely to alter a habit that is deep rooted and replace it with a new habit for the long-term. Secondly the user should be engaged with the process; and thirdly the user's attention should be focused on the process with minimal peripheral attention.

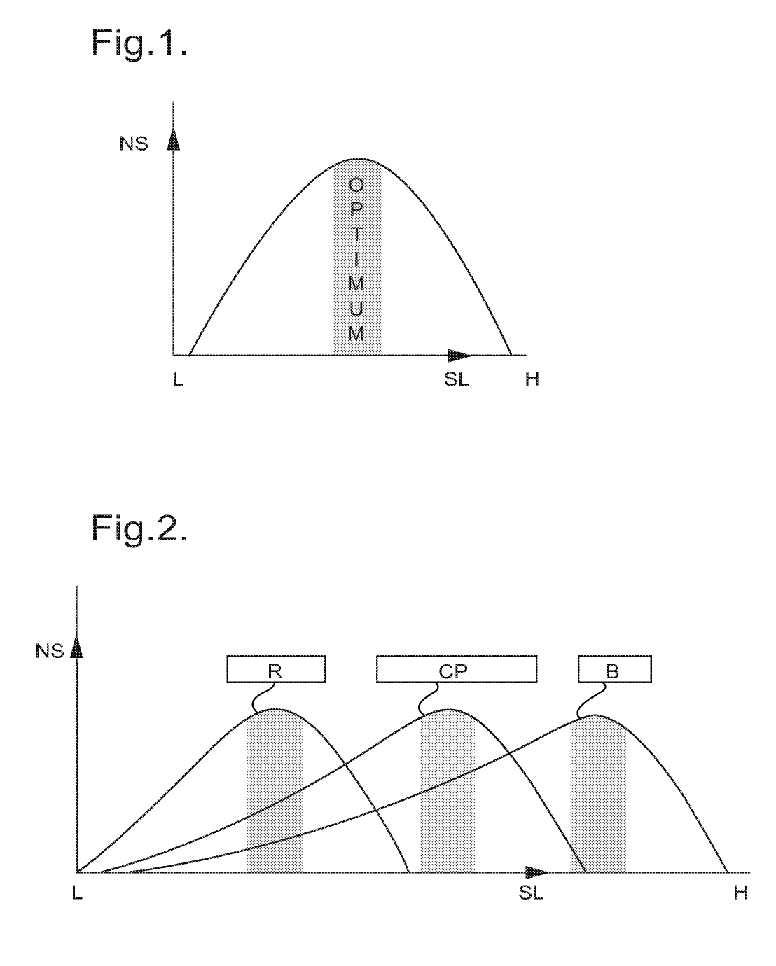

As shown in FIG. 1, there is an optimum level between being under pressure or stress and an individual's ability to perform. The vertical axis of the graph represents the “ability to acquire new skills” (NS), while the horizontal axis represents stress levels (SL). As can be seen, there is an optimum state between low (L) stress levels and high (H) stress levels where the acquisition of new skills is at a maximum. If an individual is under no stress at all, there is little or no motivation to learn new skills. If an individual is over-stressed then they are unable to process data efficiently in order to acquire those skills.

Depending on the activity that is to be modified, more “stress” or “arousal” may necessary to achieve high performance. As shown in FIG. 2, stress levels during various activities are shown. The activities are relaxation (R), completing a crossword puzzle (CP) and playing tennis (B). The stress levels during a competitive sporting activity such as tennis are much higher than when relaxed, and new skills can be learnt at these levels because a higher stress level is typical for such an activity. One aspect of the invention is that it can continuously monitor the state of mind of the user, and train him to be in this smart mindset. It can train him to have the optimal relaxed awareness level, and so coach him to have focused attention and engagement in the learning process.

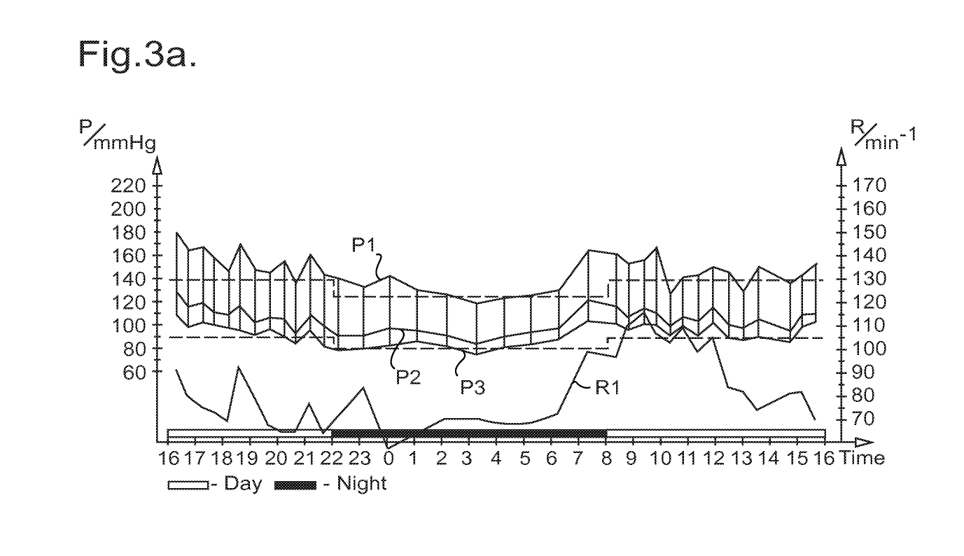

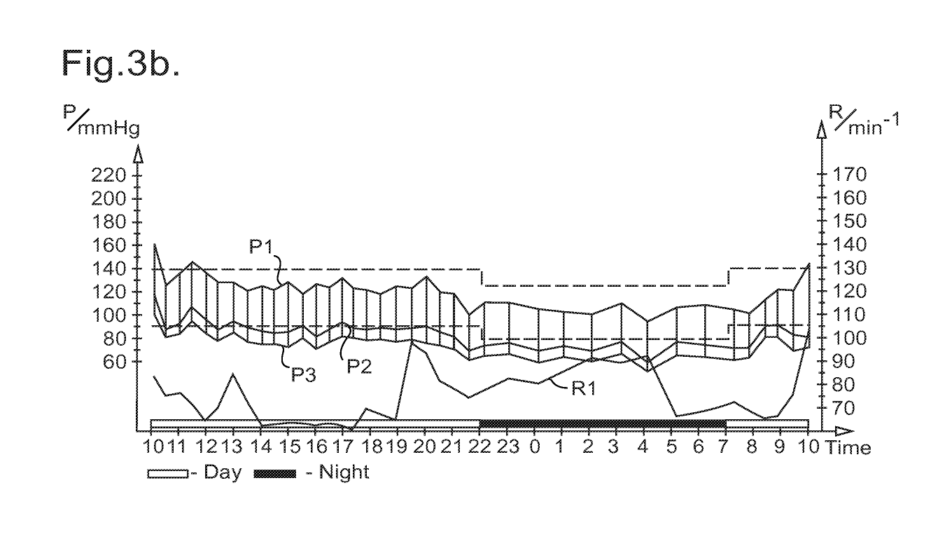

Referring now to FIG. 3, the upper graphs show measurements of blood pressure and heart rate over a 24-hour period for a patient; and the lower graphs show corresponding measurements of blood pressure and heart rate over a 24-hour period for the same patient two months later, after she had received training according to the methods described in this invention. The graphs indicate the blood pressure P (in mmHg), showing the high level (systolic), marked P1, the average marked P2, and the low level (diastolic) marked P3, these referring to the left-hand scale; and the heart rate R (beats per minute) marked R1, referring to the right-hand scale.

It will be noticed that the patient's blood pressure was significantly higher before training than after training: the systolic values P1 before training were almost always above 140 mmHg during daytime, while after training they were almost always below 140, and indeed below 130 mmHg, during daytime. Similarly the diastolic values P2 before training were almost always above 90 mmHg during daytime, while after training they were almost always at or less than 80 mmHg. It will therefore be appreciated that the training was effective in lowering blood pressure without using medication.

The current invention provides people with a system and a method whereby after initial assessment, the system can recommend to the user his modifiable risks, and how changing his behaviours can reduce his risks and increase his healthy life expectancy. The system may include an interactive module to enable the user to choose which habit he wishes to change, and to show the user how such change can reduce his risk, or how many healthy years they can expect to gain if they change a habit (for example advising on the risk of a heart attack over the next decade; or advising on the expected increase of healthy years if an unhealthy habit is stopped). In accordance with the user's choice, he is guided through the process of change and also motivated to take control over his life.

The motivational system of the present invention has a processor and an interactive protocol, whereby once a person has decided that they would like to start the process of training to change, an overall introduction to the technique may be presented, for example by an audiovisual display. The audiovisual display would talk the individual through the process of training. The audiovisual display would describe the process as including visualisation, affirmation, and self suggestion to enhance the effectiveness of the process.

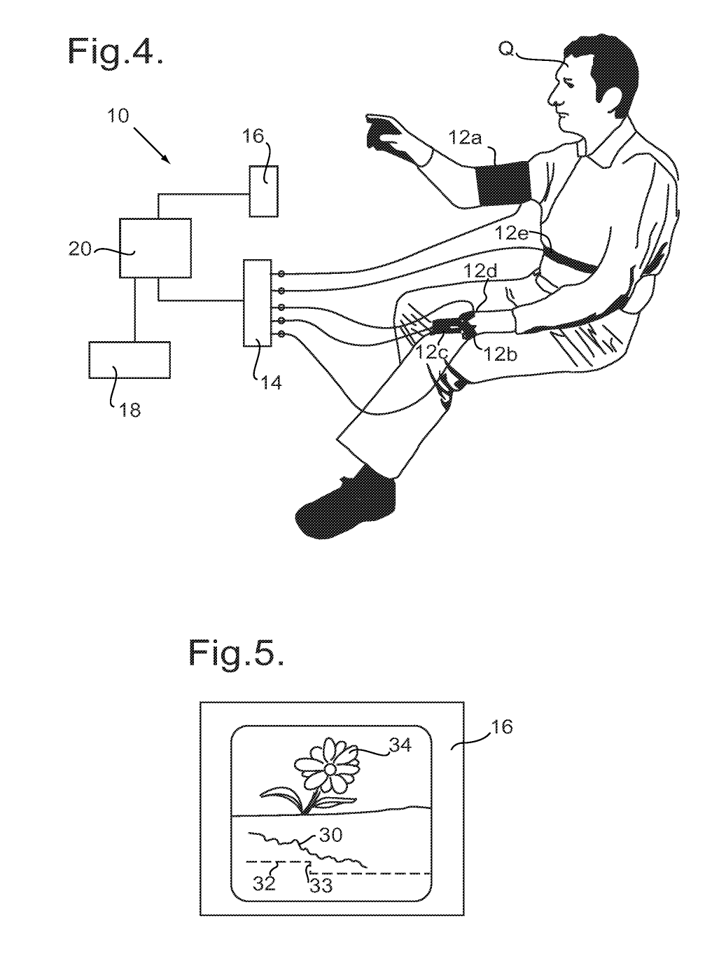

Referring now to FIG. 4 there is shown a diagram of a motivational system 10 of the invention. In this example a user Q is using an interactive multimedia behavioural modification programme (in this case to learn to reduce his blood pressure). The system 10 includes at least one sensor 12, which is connected to the person Q; the drawing shows five such sensors 12a-e. Each sensor 12 is used to measure a physiological parameter, such as heart rate, breathing rate, blood oxygen levels, blood pressure, respiratory rate, body temperature, muscle activity by way of electromyogram, heart rate variability (HRV), voice, electro-encephalograph (EEG), or galvanic skin resistance (GSR). One or more of these parameters may be measured. In this example the user Q has a cuff blood pressure sensor 12a on his upper right arm, sensors 12b-d on his left hand fingers, and a respiration sensing belt 12e on his body; the sensors on his hand are for pulse (12b), an oximeter (12c), and GSR (12d). In addition, other parameters can be measured such as pressure sensors or muscle tone sensors to check whether an individual is totally relaxed. Further, motion detectors may be used to determine whether a user is reacting to instructions that are being relayed to him, for example by slowing down breathing rate.

The sensors 12 are connected to a data processing unit 14 whose functions are described below. The unit 14 may be either fixed or mobile. The sensors 12 provide real time data about the physiological state of for example the user's heart, autonomic nervous system, or breathing technique, and this may be displayed on a display unit 16 in a simple manner that is easy to understand.

For example, heart rate may be measured using the electrocardiograph (ECG). The measured heart rate signals may be processed to extract beat intervals or various heart rate variability measurements (HRV). Alternatively HRV measurements may be taken over a period of time, for example up to five minutes, by using a small infrared sensor on the user's finger, toe or ear-lobe. During the measurement, the heart rate is measured. The infrared sensor senses the cyclical variations of the blood flow below the surface of the skin. These variations represent cardiac beat. The signal may then be digitized and analysed to calculate the exact time interval between successive heartbeats (in milliseconds). This measurement is used to create a diagram, known as a tachogram that shows the heart rate as time between beats and the tachogram can be illustrated on the visual display 16 that can be seen by the user Q who can then observe his or her heart rate on a real-time basis. Alternatively the heart rate measurements may be analysed (for example by auto-correlation or by Fourier transform, or by calculating the variance) to deduce a parameter indicative of heart rate variability.

Galvanic skin resistance (GSR) is a measure of the electrical resistance of the skin. Two electrodes are attached to separate areas of the user's skin, for example on a finger, and an electrical current is passed between the electrodes. This current is measured and compared with a base line reading taken when the user Q is relaxed. Variations in the galvanic skin resistance may be used to indicate the degree of the arousal level or relaxation of the user, because GSR is highly sensitive to changes in a user's emotional state, and responds rapidly to such changes.

It may be that signals received by the sensors 12 contain noise which corrupts data contained within the signal, and processing techniques may be used to reduce this noise. Also, a number of measurements of one parameter can be taken and the average value taken, to reduce the risk of a false reading being measured. In addition, to reduce false readings, a number of different of physiological parameters can be taken and these individual values can be compared with data for each measurement. If a particular measurement falls within acceptable values for each measurement, then this is indicative of a genuine reading. However, if one signal falls outside acceptable values then this is indicative of a possible false reading and the system may then send a signal to the sensor 12 to retest. This may be to all sensors 12 or to the individual sensor 12 that has produced an unusual reading. This can ensure that an accurate value for the physiological parameters can be obtained.

The data processing unit 14 controls the measurement process, for example the data from several different sensors 12 may be multiplexed, and the data from a sensor 12 may need to be digitised. In any event the data processing unit 14 contains a memory, and means to compare currently-measured data with previously-recorded data from the memory. The data processing unit 14 outputs not only the values of the parameters measured by the sensors 12, but the results of these comparisons.

The sensors 12 will measure the individual's physiological parameters when in a first state, and this data is recorded in memory. The sensors 12 will subsequently monitor the parameters when the individual Q is going through a process of relaxation or of learning. The motivational system 10 will use a number of techniques to relax the individual. These techniques may be used either individually or in combination depending upon the suitability of the process for a particular individual. An example would be that for a visually impaired individual, the relaxation would be by audible means rather than visual means; but as a general rule, a multimedia presentation is preferable.

The data processing unit 14 is connected to a processor 20 which monitors the state of the individual Q from the comparisons made by the data processing unit 14. As mentioned above the measured values of the parameters may be displayed by the processor 20 on the visual display 16; alternatively an indication may be displayed as to whether or not the individual's state is approaching a desired state. And when appropriate the processor 20 also changes the objective that the user Q is set by the system 10, and which is shown on the display 16.

The system 10 has a content library 18 or data input module, whereby a required goal or objective is selected or input. The objective may be selected by the user Q, or may be set by medical staff. The content library 18 may also include relaxation music, visualisations, affirmations, or self suggestions to assist an individual in reaching a state of relaxation or any desired state. The content library 18 preferably associates the selected content with a particular user Q. This means that the user Q can select the relevant programme that they find most suitable for them. Such a facility enables the user Q to be in total control of the programme. In particular, interactive breathing coaching will train the user to relax, to breathe slowly and deeply with longer exhalation. The user will also receive body posture and muscular relaxation training, plus interactive training for synchrony between heart-rate variability and breathing.

An appropriate pattern of heart rate variability is a key to physical, mental and emotional wellbeing. If the user is calm and reasonably fit, the heart rate should vary in synchrony with the breathing, and the variability is greater than when the user is under stress. Therefore, a purpose of the system 10 is to show the user Q when they are physiologically receptive to receive training information, whether it is through muscular relaxation, healthy breathing, or having an appreciative, open mindset. The physiological parameters will be displayed on the display 16 that the user Q can see. This display 16 may be part of a mobile phone, or a PC communicating with other components e.g. via cable or Bluetooth.

The display 16 can include one or a number of display images. An example, as shown in FIG. 5, would be that the display 16 could show a graph 30 that tracks a physiological parameter (such as breathing rate) and shows it as compared with a value 32 that is a current target or objective for that individual (this graph showing the variations of the physiological parameter with time). The user Q can then practice a process, for example relaxed breathing, and use this to reduce the breathing rate (or other parameter) to a level that is shown on the graph as the target value for that individual. The system 10 may give audible praise when a certain target value is reached. In any event the display 16 should always show an objective (the target value 32) selected for the user Q, whether that is a target value of a physiological parameter (during early stages), or a higher level objective set as part of a learning process (as described below). As shown at 33, the target value 32 may be altered by the processor 20, when it is appropriate to do so.

The approach to the objective may be displayed explicitly. Preferably the display image includes an image such as a flower 34, and as the user Q approaches the specified objective 32—for example as breathing rate is reduced to desired levels—the flower 34 opens. This is then a visual reward for the user Q having achieved the specified objective. Such a visual reward is more effective than the graphical display on its own.

In another example, an image such as a flying bird may be used to represent a number of different parameters simultaneously, for example with the flapping of the wings correlating with the user's breaths, and other parameters (such as heart rate variability, and galvanic skin resistance) represented by the height at which the bird flies, or its speed, or the clarity of the background image.

The system 10 includes a memory, optionally within the processor module 20, which records performance of the user Q. This will include data about how the user Q has responded to the relaxation process. The type of data that can be recorded is the length of time to reach the relaxed state, whether the individual has actually achieved a relaxed state and for how long they remain in a state of relaxation. This data is stored the memory, and may then be used to determine when the user Q has reached a target pattern that shows they are capable of relaxing when required. The processor 20 monitors the relaxation patterns and when a target pattern has been observed, indicating that the user Q has reached a state of optimum stress for learning new skills, will activate a learning programme to enable the user Q to change their behaviour (such as learning new skills or breaking old behaviour patterns). For example, considering signals from the respiration sensor 12e, for a user who is a normal adult the breathing rate when the user is in an engaged relaxed awareness state (i.e. in the flow or in a smart mindset) is typically between 5 and 8 breaths per minute, more preferably 6 breaths per minute, with the exhalation period being greater than the inhalation period; in addition his heart rate variability is above the normal value and the variation is synchronised with his breathing.

In this case the processor 20 initiates a totally new objective for the user Q (rather than just altering the target value of a parameter as shown at 33 in FIG. 5). But the processor continues to monitor the user's state, to ensure they remain in the optimal state for learning the new skill or habit, i.e. in a smart mindset.

The learning programme or learning programmes are preferably stored in the content library 18, and can be previously selected by the user Q. Such learning programmes may be specifically tailored for an individual, and may be designed by members of the medical profession or in conjunction with counsellors, for example for an alcohol or drug recovery programme. Alternatively, learning programmes may be commercially available modules, which are designed for segments of the population, for example those wanting simply to relax, or to give up smoking or to lose weight.

The system 10 shown in FIG. 4 represents the data processing unit 14, the content library 18 and the monitoring processor 20 as being separate components, but it will be appreciated that the different functions may be carried out within a single unit, and may primarily be a function of software rather than hardware. In particular, the comparator to compare current and previous values of a parameter, the monitor to deduce and monitor the state of the user, and the moderator to alter the objective accordingly, may all be carried out by a single unit.

Where the user Q has been set an objective, but the comparisons between successive signals from the sensors 12 indicate that the user Q is becoming more stressed by the pressure to achieve the objective, then the processor 20 will modify the objective to put the user Q under less stress. On the other hand, if the user Q can achieve the set objective without any noticeable stress or difficulty, then the processor 20 may modify the objective to make it more difficult to achieve. This can apply both during the initial stage of reaching the optimum state for learning new skills, and also subsequently during the programme to change their behaviour or habits.

It is to be noted that the list of goals mentioned above is not to be considered to be exhaustive. The invention may apply to a variety of applications where the user wishes to change their habits or improve their skills. A range of health issues, for example phobias, may be treated with this system, and also by improving confidence and well-being illnesses such as irritable bowel syndrome, lethargy or depression may be treated. Also, the device has applications in sporting activities or music or other areas where performance is to be improved or enhanced.

As an example, a user Q may be trained to modify several behaviours, with the aim of reducing the risk of cardio-vascular disease. The system initially monitors the user Q and interviews him using a touch screen with an attractive and easy to use multimedia display (or a mobile phone with a suitable display). It provides him with a comprehensive risk assessment taking into account several different risk factors: age, gender, family history and ethnicity (which are not modifiable), smoking, alcohol intake, activity levels, state of anxiety, nutrition, respiration, and heart rate (which are modifiable). The user may be presented with a graphic display representing his current risk, preferably in terms of expected number of healthy years. The display may include bars indicative of each of the modifiable risk factors, with a slider indicating the present value; the user can adjust the position of each slider, and the display would modify the representation of his current risk. This enables him to check what are his modifiable risks, and what may happen if he modifies any one of them.

The user's motivation is increased by the fact that the information is personal, that the display is graphical, and by the interactive nature of the display. For example the user may be shown that if he stops smoking and acquires more healthy habits (eating more fruit, exercising more) he can reduce his risk of cardiovascular disease in the next 10 years by 60% and he can gain an extra 5.6 healthy years to his life.

He can then choose the specific behaviour that he wants to change or target that he would like to achieve (e.g. to reduce his blood pressure from 160 to 130, reduce his weight etc), and the system generates for him a personalised prevention plan, and a series of interactive sessions, which include all the relevant protocols for him. This can be 8 weekly sessions which include smoking cessation (if the user is a smoker, and one objective is to stop smoking), weight reduction, and intervention to reduce and control blood pressure. The intervention to reduce blood pressure can include subsidiary objectives each designed according to this invention: an objective of improving nutritional habits, to eat more fruit and vegetables and less salt and saturated fat; an objective to acquire a habit of being more physically active; an objective of learning to relax and not being anxious; an objective of acquiring better breathing habits, etc. For each one of these objectives the system includes an interactive protocol.

For example to improve his nutritional habits the system may interview the user Q via a touch screen, presenting him with attractive images of fruits and vegetables and asks him to touch those that he likes, and to indicate how many of those he had eaten in the last week, so that the system, by interacting with the user Q, can create a healthy nutritional plan that the user likes and intends to implement during the next week. Motivation and enjoyment are enhanced by the attractiveness of the display, and its interactive nature. But in every case, each session where the user Q interacts with the system includes an engaging task such as a “Mind-Driven-Movie” which is driven and changed by the state of mind and physiology of the user, to train him to achieve the state of mind of relaxed awareness and flow, and to maintain this mental state throughout the session. For example this may consist of an image of a flower whose petals open when the user Q is in this state, and whose petals are closed otherwise.

It will be appreciated that the embodiments described above are given by way of example only and are not intended to limit the invention, the scope of which is determined by the attached claims. It is to be understood that the features described in one embodiment of the invention can be used either individually or collectively in other embodiments of the invention.

As explained above the behaviour modification system requires sensors that measure parameters of the user. The user may therefore attend training sessions using the behaviour modification system, for example at a doctor's surgery, and at each such session he would be taught how to achieve the current objectives. The user may be provided with a practising device (e.g. software installed for example on his mobile phone) to provide guidance about achieving his objective, so that he can practise in his own time between visits to the training sessions at the doctor's surgery. In this case the practising device may incorporate just a single sensor, or alternatively may provide no sensors. Such a sensor-less device clearly does not provide the full functionality to the user, but nevertheless can help the user practise the techniques he has learnt during the training sessions. In a particularly simple embodiment, where the practising device is a mobile phone, the sensor may be the microphone of the mobile phone, or may be a camera of the mobile phone, so that all the elements of the system may be incorporated into the mobile phone.

What is claimed:

1. A behaviour modification system to facilitate the achieving by a user of one or more objectives, said system including
a) one or more sensors to measure at least one physiological, psychological, or behavioural parameter of the user;
b) a memory to store data concerning the measured parameter or a range of measured parameters for the user, based on information from the sensors at at least one point in time;
c) a comparator to compare the at least one measured parameter at subsequent points in time with stored data for the user;
d) an indicator to provide information to the user about one or more objectives that the user wishes to achieve;
e) a monitor that, based on comparisons made by the comparator, monitors the state of the user when working towards the at least one objective; and
f) a moderator that, in response to the state of the user as monitored by the monitor, enables the at least one objective to be changed so that the user is able to maintain a desired state when attempting the at least one objective thereby maintaining engagement of the user to continue working towards the at least one objective.

2. A behaviour modification system as claimed in claim 1 wherein the memory stores data based on information from the sensors at several points in time; and the system comprises an electronic device including processor and memory, which can store process and update protocols to coach users to improve their behaviour according to at least one of the following elements: present state of the user, past states of the user, user medical history, user psychological history, user symptoms, user constitution, user preferences, user nutrition and eating habits, other user habits including addictions, medical knowledge, psychological knowledge, sport expertise, music expertise, short term objective, long term objective, or any combination of the previous elements.

3. A behaviour modification system according to claim 1, wherein the system can coach the user using at least one of the following media: audio, visual, multimedia, video, tactile and vibration, or any combinations of the previous media.

4. A behaviour modification system comprising one or more sensors to measure at least one physiological or psychological or behavioural parameter of the user; and an electronic device provided with a multimedia display and responsive to the measured parameter, the electronic device being arranged to train the user, using the multimedia display, to achieve a state of mind in which the user is engaged and focused on an achievable task; and then, when the user has this state of mind, to train the user to achieve a desired objective.

5. A behaviour modification system according to claim 4, wherein the system will implement at least one of the following: increase user's intrinsic motivation, increase user's extrinsic motivation, interview the user to discover his objections to specific changes and his readiness to specific changes and coach him accordingly, increase the user's confidence, train the user to improve his state of mind and body to be more open to learn and change, add specific elements during the coaching session so that the user will enjoy the coaching process, coach the user how he can enjoy his life more when he implements the desired changes in his life, coach the user to repeat new methods that he is learning several times during the sessions, coach the user to practice new methods that he is learning many times in his daily life, give the user a personal progress plan to implement in his daily life according to his needs, review how the user has implemented his personal plan, coach the user using cognitive behavioural therapy, coach the user using positive psychology methods, coach the user using emotional intelligence methods, coach the user according to his belief, or any combination of the previous methods.

6. A behaviour modification system according to claim 1, wherein the system will implement all of the following: train the user to improve his state of mind and body to be in a receptive state, and will increase the user's motivation, increase the user's confidence, and coach the user to repeat new methods that he is learning several times.

7. A behaviour modification system according to claim 1, wherein the system comprises a plurality of different sensors measuring a plurality of different parameters.

8. A system according to claim 2, wherein the electronic device is in a mobile communications device.

9. A system according to claim 1, wherein the interface with the user comprises one of the following: television, computer monitor, touch screen, mobile phone, PDA, or an audio player.

10. A system according to claim 1, wherein the physiological parameters measured for the user are shown as a first image and a second image is provided showing a range of values that indicate a desired state for the user.

11. A system according to claim 1, wherein the physiological parameters measured for the user are compared by the processor to a desired value range for this user at this stage, and if they are within this range a motivational reward is generated and provided to the user, whereas a warning signal may be presented if his physiological parameters are in undesirable range.

12. A method of facilitating the achieving by a user of one or more objectives, said method including the steps of:
a) measuring at least one physiological or psychological parameter of the user;
b) storing data concerning the physiological or psychological parameter or a range of physiological or psychological parameters for the user, based on information at at least one point in time;
c) comparing the at least one measured parameter at subsequent points in time with stored data for the user;
d) providing an indication to the user about one or more objectives that the user wishes to achieve;
e) monitoring, on the basis of the said comparisons, the state of the user when working towards the at least one objective; and
f) moderating, in response to the monitored state of the user, the at least one objective by amending the objective so that the user is able to maintain a desired state when attempting the at least one objective thereby maintaining engagement of the user to continue working towards the at least one objective.

13. A method of facilitating the achieving by a user a desirable behaviour modification change and achieving by a user of one or more objectives, said method including:
a) measuring at least one of the following parameters of the user: physiological, psychological, or behavioural;
b) storing the data concerning the measured parameter or a range of measured parameters for the user, based on information from the sensors at several points in time;
c) comparing the at least one measured parameter at subsequent points in time with stored data for the user;
d) providing information to the user about one or more objectives that the user wishes to achieve;
e) monitoring, on the basis of the said comparisons, the state of the user when working towards the at least one objective; and
f) moderating, in response to the monitored state of the user, the at least one objective by amending the objective so that the user is able to maintain a desired state when attempting the at least one objective thereby maintaining engagement of the user to continue working towards the at least one objective; and
g) coaching the users according to a protocol to improve their behaviour according to at least one of the following elements: present state of the user, past states of the user, user medical history, user psychological history, user symptoms, user constitution, user preferences, user nutrition and eating habits, other user habits including addictions, medical knowledge, psychological knowledge, sport expertise, music expertise, short term objective, long term objective, or any combination of the previous elements.

14. A method of facilitating the achieving by a user of one or more desirable behaviour modification changes, said method including the steps of: measuring at least one physiological, psychological or behavioural parameter of the user; and by means of an electronic device provided with a multimedia display and responsive to the measured parameter, training the user, using the multimedia display, to achieve a state of mind in which the user is engaged and focused on an achievable task; and then, when the user has this state of mind, training the user to achieve a desired objective.

15. A behaviour modification method according to claim 12, wherein the system will implement all of the following: increase user's motivation, increase the user's confidence, train the user to improve his state of mind and body to achieve a receptive state, and coach the user to repeat new methods that he is learning several times.

16. A behaviour modification method according to claim 15, wherein the method uses a plurality of different sensors measuring a plurality of different physiological parameters.

17. A method according to claim 12, wherein data concerning the user is transmitted to a memory of a mobile communications device.

18. A method according to claim 17, wherein the mobile communications device includes a display so that a visual representation of the measured parameter can be seen, and wherein a visual representation is shown of the measured parameter in real time so that the user can have a visual indication of how their body is performing at a given point in time.
